(19) United States
(12) Patent Application Publication
(10) Pub. No.: US 2023/0192032 A1
(43) Pub. Date: Jun. 22, 2023

(54) Method and Device For a Receiver For Locating an Authentication Unit of a Motor Vehicle

(71) Applicant: Bayerische Motoren Werke Aktiengesellschaft, Muenchen (DE)

(72) Inventors: Benjamin Schulz, Dresden (DE); Daniel Knobloch, Cupertino, CA (US)

(21) Appl. No.: 17/928,868

(22) PCT Filed: Mar. 31, 2021
(86) PCT No.: PCT/EP2021/058401

§ 371 Date: Nov. 30, 2022

(30) Foreign Application Priority Data
Jul. 1, 2020 (DE) 10 2020 117 377.6

(51) Int. Cl. B60R 25/24; B60R 25/20

(52) U.S. Cl. CPC B60R 25/245; B60R 25/2072; B60R 2325/101

(57) ABSTRACT

A method for a receiver locates an authentication unit of a motor vehicle. The method includes determining environment information relating to the receiver. The method also includes receiving a reception signal from a transmitter. The method further includes determining a relative position of the transmitter with respect to the receiver on the basis of the environment information and the reception signal.

The present application is the U.S. national phase of PCT Application PCT/EP2021/058401 filed on Mar. 31, 2021, which claims priority of German patent application No. 102020117377.6 filed on Jul. 1, 2020, which is incorporated herein by reference in its entirety.

### TECHNICAL FIELD

Exemplary embodiments relate to a method, a device, a motor vehicle and a computer program for a receiver for locating an authentication unit of a motor vehicle, in particular with the locating process being carried out by means of environment and distance information relating to the authentication unit of the motor vehicle.

### BACKGROUND

A prerequisite for using so-called keyless entry systems (also called passive entry/passive go systems) is to develop a secure and simultaneously robust method for authenticating the authorized user with respect to the motor vehicle.

This also includes a sufficiently accurate estimation of the location of the user or of the authentication unit (as of when a motor vehicle can be unlocked or is intended to be locked) and whether the authentication unit (for example a smartphone or a smart key) is situated inside or outside the motor vehicle in order to grant or refuse approval to start an engine.

In conventional smart keys, this estimation is carried out at very low radio frequencies. Currently, most passive entry systems are based on narrowband radio technologies in the LF band (low-frequency band, also long-wave band). As soon as the distance between the smart key and the motor vehicle is short enough, the smart key sets up a connection to the motor vehicle. After the connection has been established, a locating process is carried out in another LF frequency band. In this case, a defined signal is emitted by the smart key, and, depending on the position in relation to the motor vehicle, one or more receiving antennas receive this signal with different signal strengths. The reason for this is attenuation of an electromagnetic wave in different materials. Depending on the reception power of the signal at the various receiving nodes, a decision can be made as to whether the smart key is close enough to the motor vehicle or is situated inside the motor vehicle.

Accurately locating the smart key, in particular determining whether a smart key is situated inside or outside a motor vehicle, may be problematic when using LF frequencies.

### SUMMARY

There is a need to provide an improved approach to using smart keys as motor vehicle keys.

This need is taken into account by the exemplary embodiments of the present disclosure.

Exemplary embodiments of the present disclosure are based on the knowledge that it is possible to improve a process of locating a smart key at higher frequencies.

Since a motor vehicle constitutes a complex geometry, the electromagnetic behavior of which cannot be easily calculated, machine learning processes are used here, that is to say training data are measured on the motor vehicle, for example, and are transferred to a machine learning model (ML model), with the result that the motor vehicle can then classify whether an authentication unit is situated inside or outside a motor vehicle. The entire solution space is ideally covered, with the result that the classification does not fail at any point (incorrect classification or blind spot). In this case, the process in some cases is that a person holds a smart key at defined positions in the motor vehicle, at the motor vehicle and around the motor vehicle. In this case, the person carrying out the measurement knows whether the smart key is currently situated inside, outside or in the trunk. The power values of the various receiving nodes are then linked to one another using this knowledge (inside, outside (includes in the trunk)). In some cases, such a training data set is recorded in an environment which is not highly specified. This suffices for measurements in the low-frequency range since the properties of the radio frequencies used for this purpose are sufficiently independent of the environment that such methods suffice. The ML model is then formed and a check is carried out in order to determine whether the model is working.

Some newer smart keys use a different technology than LF radio, ultra wideband (UWB). This type of radio technology fundamentally differs from LF radio in that, instead of a powerful narrowband signal (that is to say low-frequency information is modulated onto a higher carrier frequency), a very wideband but low-power signal is transmitted in the SHF band (super high frequency, centimeter wave band, 3-30 GHz).

A precise time-of-flight (ToF) measurement can be carried out by using a very broad spectrum (of at least 500 MHz, for example). Measuring the ToF then makes it possible to calculate the distance between the transmitter and the receiver using the constant of the speed of light. In addition to the ToF, the receive power (RXP) can likewise be used as a second feature for calculating the distance. In principle, it is possible to also apply the data processing process and the training of the ML model to this radio technology.

As a result of the high frequencies and therefore short wavelengths (approximately 3 to 7 cm) of the electromagnetic waves, the interfering influences of metal objects in the area surrounding the transmitter and the receiver are substantially greater than those in the LF band. An electromagnetic wave interacts very strongly at conductive geometries of the order of magnitude of the wavelength, that is to say the wave is reflected, scattered and diffracted. LF radio has a wavelength order of magnitude in the single-digit kilometer range, which is why there are few interactions with metal objects, which are small in relation to the wavelength, in LF radio. However, at wavelengths in the centimeter range, the body/engine block, other motor vehicles, reinforced concrete walls, gratings etc. cause a lot of interference. This is also due, inter alia, to the penetration depth of the waves into a conductor. The higher the frequency of the electromagnetic wave, the lower the penetration depth into this conductor or the possibility of even penetrating this conductor. This penetration depth is approximately 100 μm for LF radio, and is approximately 1 μm for SHF. That is to say, high frequencies can be shielded much more easily than lower frequencies. In addition, the free space loss is proportional to the frequency, which in turn means that the UWB waves are already attenuated to a greater extent solely on account of their higher frequency. In addition, high-frequency waves are attenuated to a greater extent than low-frequency waves in non-transparent objects such as water or humidity.

The short wavelengths of UWB, in particular in the higher channels, result in a high dependence on the environment. That is to say, depending on the environment in which the user is situated—for example in his own garage or between two motor vehicles in the supermarket parking lot—the received signal from the authentication unit at the motor vehicle is very different (even though the authentication unit is at the same location relative to the motor vehicle). The ML model fails, in particular, in highly reflective environments, since the additional reflection paths and the higher reception power overlap other data of a different kind and therefore cannot be distinguished. As a result, locating a smart key, in particular determining whether a smart key is situated inside or outside a motor vehicle, may be problematic.

Exemplary embodiments of the present disclosure deal with improving an algorithm for classifying the authentication unit, in particular locating the authentication unit. The classification makes it possible to decide whether an authentication unit (for example a smart key (also key fob) or a smartphone) is situated in the interior or exterior of the motor vehicle. In this case, exemplary embodiments of the present disclosure are based on the knowledge that a process of locating an authentication unit can be improved by combining environment information relating to the authentication unit with information relating to the distance between the authentication unit and a motor vehicle. For example, determination of the distance information relating to the authentication unit may be influenced and distorted by a region which reflects UWB waves, for example a reinforced concrete wall, with the result that the authentication unit cannot be reliably located. Taking into account the environment information relating to the authentication unit makes it possible to take into account the reflective region when locating the authentication unit, thus making it possible to improve a locating process.

A method according to an embodiment for a receiver for locating an authentication unit of a motor vehicle comprises determining environment information relating to the receiver, receiving a reception signal from a transmitter, and determining a relative position of the transmitter with respect to the receiver on the basis of the environment information and the reception signal. Determining the environment information makes it possible to analyze the reception signal with respect to a reflection at an environmental structure. For example, a reception signal gain caused by a reflection of a transmission signal emitted by the transmitter at an environmental structure that reflects UWB waves may therefore be taken into account when determining the relative position. This makes it possible to improve the determination of the relative position.

The environment information can be determined using various possibilities, for example by means of a measurement. For example, one embodiment may comprise receiving a further reception signal from a further transmitter or a reflector and determining the environment information on the basis of the further reception signal. This makes it possible to specifically determine the environment information for the respective application, thus making it possible to improve the process of locating the authentication unit.

Alternatively or additionally, the determination of the environment information may comprise a signal analysis of the further reception signal with respect to a time-of-flight and/or a signal strength and/or a signal waveform. The signal analysis makes it possible to improve the process of locating the authentication unit on the basis of a greater depth of information relating to the further reception signal. A further embodiment may comprise transmitting a transmission signal for reflection at the reflector in order to receive the further reception signal. The reflection at the reflector makes it possible to improve determination of the environment information.

Furthermore, the environment information may be determined only in certain situations. For example, one embodiment may comprise receiving a starting signal from the transmitter before determining the environment information. This makes it possible to improve energy management of the motor vehicle by means of specific, for example only one-off, determination of the environment information.

Alternatively or additionally, the environment information may be determined by means of a plurality of further reception signals. This makes it possible to improve interpolation when locating the authentication unit. In particular, in one embodiment, the determination of the relative position may comprise determination by means of a machine learning algorithm.

Exemplary embodiments of the present disclosure also comprise a device for a receiver for locating an authentication unit of a motor vehicle. The device comprises at least one interface for communicating with one or more transmitters, and a control module. The control module is designed to locate an authentication unit of a motor vehicle. The device may comprise one or more processors and/or one or more memory devices. Exemplary embodiments also provide a motor vehicle having a computing module, wherein the computing module is designed to determine a relative position of the transmitter with respect to the receiver with the aid of the environment information and the reception signal.

Alternatively or additionally, in one embodiment, a motor vehicle may comprise a device for a receiver for locating an authentication unit of a motor vehicle. In one embodiment, the motor vehicle may also comprise a further transmitter which is designed to generate a transmission signal. The control module is also designed to receive a further reception signal from the further transmitter or a reflector and to determine the environment information on the basis of the further reception signal.

Exemplary embodiments of the present disclosure also comprise a program having a program code for carrying out at least one of the methods when the program code is executed on a computer, a processor, a control module or a programmable hardware component.

### BRIEF DESCRIPTION OF THE FIGURES

Some examples of devices and/or methods are explained in more detail below, merely by way of example, with reference to the accompanying figures, in which:

FIG. 1 shows a block diagram of an exemplary embodiment of a method according to the disclosure;

FIG. 2 shows a block diagram of a further exemplary embodiment of a method according to the disclosure;

FIG. 3 shows a block diagram of an exemplary embodiment of a device according to the disclosure; and

FIG. 4 shows a message sequence chart of a method according to the disclosure.

### DETAILED DESCRIPTION

Various examples are now described in more detail with reference to the accompanying figures which illustrate some examples. In the figures, the thicknesses of lines, layers and/or areas may be exaggerated for clarification.

It will be appreciated that if an element is referred to as being “connected” or “coupled” to another element, the elements may be connected or coupled directly or via one or more intermediate elements. If two elements A and B are combined using an “or”, this should be understood as meaning the fact that all possible combinations are disclosed, that is to say only A, only B and A and B, unless explicitly or implicitly defined otherwise. An alternative expression for the same combinations is “at least one of A and B” or “A and/or B”. The same applies, mutatis mutandis, to combinations of more than two elements.

Unless defined otherwise, all terms (including technical and scientific terms) are used here in their conventional meaning in the field to which examples belong.

Exemplary embodiments of the present disclosure generally deal with locating an authentication unit of a motor vehicle, for instance a smart key, inside or outside a motor vehicle. Exemplary embodiments therefore relate, in particular, to an authentication unit of a motor vehicle for keyless entry systems and keyless go systems.

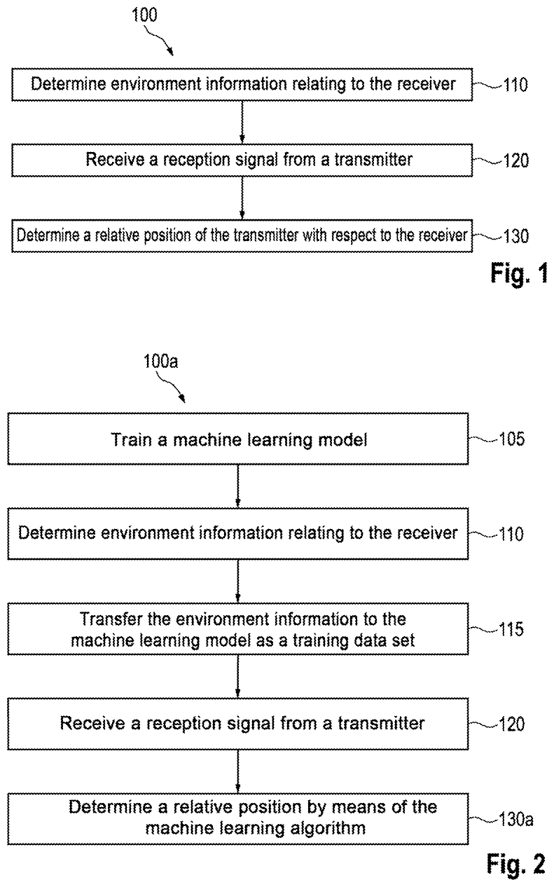

FIG. 1 shows a block diagram of an exemplary embodiment of a method according to the invention. The method 100 comprises determining environment information relating to the receiver 110, receiving a reception signal from a transmitter 120, and determining a relative position of the transmitter with respect to the receiver 130 on the basis of the environment information and the reception signal.

Environment information in the sense of this disclosure may be considered to be, on the one hand, information relating to structures outside the motor vehicle, that is to say walls/ceilings of a garage or other motor vehicles, for example. In addition, the environment information may comprise information relating to structures inside the vehicle, that is to say a payload or passengers, for example. In this case, only structures which interact with UWB waves may be of interest for determining the environment information.

The environment information may be determined 110, for example, by determining a location of the motor vehicle, wherein environment information may be/have been assigned to the determined location. In this case, the location of the motor vehicle may be determined, for example, by means of GPS positioning, GSM positioning, WLAN-based positioning, by means of route information input by a user and/or by means of a sensor of the motor vehicle for determining environment information relating to the motor vehicle, for example a camera. In particular, the location may be determined if a motor vehicle engine is manually switched off, the motor vehicle reaches a regularly used location, for example a home address or a work address, and/or a camera detects known environment information, for example a garage.

The environment information for a determined location can be assigned using a plurality of possibilities. For example, the environment information may comprise a data set which was determined at a location and/or has been assigned to a location. For example, for a motor vehicle, a data set may have been determined at a location in a parking garage by means of measurement, with the result that it is possible to use the data set for precisely this location in the parking garage. The determination of a data set of the environment information by means of measurement may comprise, for example, measurements for determining different relative positions of the authentication unit in a motor vehicle environment, for instance at a plurality of predefined positions inside and outside the motor vehicle. Alternatively or additionally, the data set may be assigned to a plurality of locations in this parking garage, for example because the plurality of locations in the parking garage are similar owing to a low ceiling height or are virtually identical, for example adjacent parking areas without adjacent walls or pillars. In addition, a structural similarity of different parking garages may be known from building information, with the result that the data set can be used for a plurality of parking garages. For example, open flat terrain, also called free field, for example an agriculturally used undeveloped area, may be known on the basis of map information, with the result that a data set determined by means of a measurement can be used for a plurality of locations or for any desired location in the free field. This makes it possible to reduce an effort needed to determine the environment information by determining a data set for a location and assigning this data set to other locations having similar or identical structures at the location.

Alternatively or additionally, the data set of environment information relating to a location may be generated using a simulation, in particular a physical simulation. In other words, the environment information may comprise at least one data set based on a physical simulation of a first location. For example, a data set for a location, for example a free field, can be determined without measurement, thus making it possible to reduce a measurement effort needed to create a data set of environment information. For example, the physical simulation may correspond to a field simulation. For this purpose, it is possible to create a model of the motor vehicle at a simulated location. A plurality of spatial points, at which synthetic measurements are calculated on the basis of physical parameters, for instance free space loss, attenuation by a propagation medium, reflections at the motor vehicle and at structures at the location, shading of the transmission signal at parts of the motor vehicle and structures at the location, increase in the time-of-flight and attenuation caused by non-line-of-sight transmission etc., may be defined inside and outside the motor vehicle. In this case, reflections outside the vehicle can be disregarded for the purpose of simulating a location of a motor vehicle, as a result of which a simulation for a free field may result. In order to simulate a further location, a plurality of additional reflective surfaces outside, and optionally inside, the vehicle can be introduced into the model. Alternatively or additionally, the data set of environment information relating to a location may be determined using an ML algorithm (see FIG. 2).

A reception signal may be received 120 by means of an armature of the motor vehicle. The transmitter may be an authentication unit, for example. In other words, the reception signal may have been emitted by an authentication unit. The reception signal emitted by an authentication unit may be a UWB wave. The UWB wave may correspond to a delta function or a delta substitute function, for example a Gaussian curve or a Lorenz curve. The reception signal may have reached the receiver only on “line-of-sight” (LOS) paths; for example, this may occur in a free-field environment. In other words, the reception signal may not contain any reflections of the UWB wave at environmental structures. This in turn results in an availability, the ratio between received packets and transmitted packets, being low. Alternatively, the reception signal may comprise a reflected portion, that is to say portions from “non-LOS” paths, also called echo; for example, this may occur in a parking garage with a low reinforced concrete ceiling. This in turn results in increased availability. Accordingly, the reception signal may differ considerably depending on a location for an identical relative position of the authentication unit with respect to the motor vehicle, for example in terms of a signal strength or echoes which occur. In particular, determination of the relative position by means of a time-of-flight distance measurement on the basis of the reception signal dependent on a location may be extremely difficult.

When determining the relative position of the transmitter with respect to the receiver 130, recourse is therefore had to the environment information and the reception signal. Combining the environment information with information from the reception signal makes it possible to determine the relative position more accurately, thus making it possible to improve the process of locating the authentication unit. A corresponding relative position may be assigned to a reception signal at a location. In this case, the relative position of the authentication unit relative to the motor vehicle may be classified, for example, according to one of two or three categories, for instance “inside the motor vehicle interior”, “outside the motor vehicle” and optionally “in the trunk”. Alternatively, the relative position of the authentication unit relative to the vehicle may be specified in a sector-based system relative to the vehicle. For example, corresponding positions may be assigned to different reception signals by means of measurements, for example at a plurality of predefined relative positions of the authentication unit with respect to the motor vehicle and/or at locations with different structures. This makes it possible to improve the process of locating the authentication unit for a plurality of locations with different structures.

A further embodiment of the method comprises receiving a further reception signal from a further transmitter or a reflector and determining the environment information on the basis of the further reception signal. Receiving a further reception signal makes it possible to determine environment information at a location. It is therefore possible to dispense with prior generation of a data set for a location. This makes it possible, in principle, to improve the process of locating the authentication unit at any location by determining an environment of the location and to reduce the time needed to generate the environment information. The environment information may be determined by means of an electromagnetic wave, for example a UWB wave or a light wave. The further transmitter may be an armature of the motor vehicle. The further reception signal transmitted by the further transmitter may, for a UWB wave or a light wave, correspond to a delta function or a delta substitute function, for example a Gaussian curve or a Lorenz curve. The received further reception signal from a further transmitter, for example an armature of the motor vehicle, may comprise only non-LOS paths. In other words, the further reception signal from a further transmitter comprises only information relating to reflective structures in the environment. The further transmitter may transmit further reception signals at intervals of time, which reception signals are reflected, refracted and/or scattered to different extents depending on the environment. The further reception signals from the further transmitter provide conclusions about the environment. These further reception signals from the further transmitter can then be used as further features in an ML algorithm. The intervals of time may vary; for example, the further transmitter may alternately transmit a plurality of further reception signals for determining the environment information within a time x and may then transmit no further reception signal within a time y in order to reduce an energy requirement. This makes it possible to update environment information at regular intervals and with a reduced energy requirement. The further transmitter may be integrated in the receiver or the further transmitter and the receiver may be formed from one component; for example, the further transmitter and the receiver may be formed by an armature of the motor vehicle. As a result, the method according to the invention can be carried out solely with an infrastructure present in the motor vehicle.

The reflector may be a structure in the environment of the location that interacts with an electromagnetic wave, for example a UWB wave or a light wave, or a sound wave. The received further reception signal from a reflector may comprise both LOS paths and non-LOS paths. The reflector may reflect a signal from an external source, for example the sun or a radio network, with the result that an energy requirement for emitting signals can be reduced by using the reflector. For example, a structure such as a parking bay in a parking garage may be detected and its dimensions determined by means of a camera recording. Environment information for the location can be created on this basis, for example by assigning a data set to a comparable environment of another location. This procedure is an example of the use of light waves, but may be used for any form of electromagnetic waves, for example UWB waves, or other waveforms, for example sound waves.

In a further embodiment of the method, the determination of the environment information comprises a signal analysis of the further reception signal with respect to a time-of-flight and/or a signal strength and/or a signal waveform. Determining a time-of-flight and/or a signal strength and/or a signal waveform makes it possible to improve the determination of the environment information, for example by assigning a data set. The additionally determined parameters of the time-of-flight, signal strength and/or signal waveform make it possible to better distinguish different locations with similar environments from one another. As a result, an improved selection can be made when assigning a data set to a location, thus making it possible to improve the process of locating the authentication apparatus. Furthermore, the additional parameters can be used as features for an ML model. Alternatively or additionally, the method may also comprise transmitting a transmission signal for reflection at the reflector in order to receive the further reception signal. Transmitting a transmission signal for reflection at the reflector makes it possible to carry out a comparison between the transmission signal and the further reception signal. For example, a ToF distance measurement can be carried out by means of a time-of-flight analysis (ToF) of the transmission signal or of the further reception signal. This makes it possible to improve determination of a dimension of an environment. Furthermore, evaluation of echoes caused by structures in the environment can be improved by virtue of the precisely known transmission signal. Properties of the structures in the environment, for example a material, can also be inferred on the basis of the changes in the signal intensity between the transmission signal and the further reception signal. As a result, an improved selection can be made when assigning a data set to a location, thus making it possible to improve the process of locating the authentication apparatus. Furthermore, an ML algorithm can be supplied with a valid data base.

A further embodiment of the method comprises receiving a starting signal from the transmitter before determining the environment information. Receiving a starting signal from the transmitter means that environment information can be determined only when the transmitter is in range. For example, an environment of a location may change as a result of other motor vehicles driving into and/or out of parking spaces. The reception of a starting signal, for example via Bluetooth, makes it possible to reduce an energy requirement for determining the environment information since continuous operation can be avoided and the environment information is determined only when required.

A further embodiment of the method comprises determining the environment information by means of a plurality of further reception signals. Using the plurality of further reception signals makes it possible to improve a data set makes it possible to improve the determination of the environment information, for example by assigning a data set. The additional further reception signals make it possible to better distinguish different locations with similar environments from one another. As a result, an improved selection can be made when assigning a data set to a location, thus making it possible to improve the process of locating the authentication apparatus. Furthermore, the additional further reception signals can be used for an ML algorithm. The plurality of further reception signals may be transmitted by a plurality of further transmitters. The plurality of further reception signals may be received by a plurality of receivers. A number of the further transmitters may be identical to a number of the receivers. For example, one further transmitter may be integrated in one receiver in each case. For example, the plurality of further transmitters and the plurality of receivers may be formed by a plurality of armatures of the motor vehicle. As a result, the method according to the invention can be carried out solely with an infrastructure present in the motor vehicle. The armatures of the plurality of armatures may transmit transmission signals at the same time and/or alternately. A transmission signal transmitted by an armature, for example a UWB transmission signal, may be received and analyzed by the same armature. A transmission signal transmitted by an armature, for example a UWB transmission signal, may be received and analyzed by all other armatures of the motor vehicle. This makes it possible to increase a depth of information for assigning a data set and/or for an ML algorithm. For example, the plurality of further transmitters alternately transmit transmission signals which are reflected, refracted and/or scattered to different extents depending on the environment. The further reception signals received by the plurality of receivers provide conclusions about the environment. These received signals can then be used as further features in the ML algorithm.

More details and aspects of the method and of the device are mentioned in connection with the concept or examples described above or below (FIGS. 2-4). The method and the device may comprise one or more additional optional features corresponding to one or more aspects of the proposed concept or of the described examples, as described above or below.

FIG. 2 shows a block diagram of an exemplary embodiment of a method according to the invention. In the method 100a, the determination of the relative position comprises determination by means of a machine learning model 130a. The method also comprises training of the machine learning model 105, determining environment information relating to the receiver 110, transferring the environment information to the machine learning algorithm as a training data set 115, receiving a reception signal from a transmitter 120 and determining a relative position by means of the machine learning model 130a on the basis of the environment information and the reception signal.

In order to improve the ML algorithm for classifying the authentication unit, an environment analysis can be carried out using the transceivers of a motor vehicle, which have already been installed and can be used as further transmitters and receivers, in order to therefore be able to use further features for better classification.

ML algorithms are normally based on an ML model. In other words, the term “ML algorithm” may denote a set of instructions which can be used to create, train or use an ML model. The term “ML model” may denote a data structure and/or a set of rules representing the knowledge learnt (for example on the basis of the training carried out by means of the machine learning algorithm). In exemplary embodiments, the use of an ML algorithm may imply the use of an underlying ML model (or a plurality of underlying ML models). The use of an ML model may imply that the ML model and/or the data structure/the set of rules, which is/are the ML model, is/are trained by means of an ML algorithm.

For example, the ML model may be an artificial neural network (ANN). ANNs are systems which are inspired by biological neural networks, as can be found in a retina or a brain. ANNs comprise a plurality of interconnected nodes and a plurality of connections, so-called edges, between the nodes. There are normally three node types: input nodes which receive input values, concealed nodes which are connected (only) to other nodes, and output nodes which provide output values. Each node may represent an artificial neuron. Each edge may send information from one node to another. The output of a node may be defined as a (non-linear) function of the inputs (for example the sum of its inputs). The inputs of a node may be used in the function on the basis of a “weight” of the edge or of the node which provides the input. The weight of nodes and/or of edges can be adapted in the learning process. In other words, the training of an ANN may comprise adapting the weights of the nodes and/or edges of the ANN, that is to say in order to achieve a desired output for a particular input.

Alternatively, the ML model may be a support vector machine, a random forest model or a gradient boosting model. Support vector machines are supervised learning models with associated learning algorithms which can be used to analyze data (for example in a classification or regression analysis). Support vector machines may be trained by providing an input having a plurality of training input values which belong to one of two categories. The support vector machine may be trained to assign a new input value to one of the two categories. Alternatively, the ML model may be a Bayesian network which is a probabilistic directed acyclic graphical model. A Bayesian network may represent a set of random variables and their conditional dependencies using a directed acyclic graph. Alternatively, the ML model may be based on a genetic algorithm which is a search algorithm and heuristic technology which imitates the process of natural selection.

An ML algorithm may relate to statistical models which can be used by computer systems to carry out a specific task without using explicit instructions, instead of relying on models and inference. In the case of machine learning, instead of a rule-based transformation of data, it is possible to use, for example, a transformation of data which may be derived from an analysis of progress and/or training data. Machine learning is used in a multiplicity of applications, for instance for recognizing objects in image data, for predicting time series, for pattern analysis etc. In this case, use is generally made of the fact that, in order to train an ML model which is intended to carry out a particular task, the so-called “training” of the model, so-called training data suffice as a basis in many cases, that is to say data which represent an example of which transformation is expected from the respective ML model.

For example, the content of images can be analyzed using an ML model or using an ML algorithm. So that the ML model can analyze the content of an image, the ML model can be trained using training images as an input and training content information as an output. As a result of the ML model being trained with a large number of training images and/or training sequences (for example words or sentences) and associated training content information (for example labels or comments), the ML model “learns” to recognize the content of the images, with the result that the content of images which are not included in the training data can be recognized using the ML model. The same principle may likewise be used for other types of sensor data: as a result of an ML model being trained using training sensor data and a desired output, the ML model “learns” a conversion between the sensor data and the output, which can be used to provide an output on the basis of non-training sensor data made available to the ML model. The data provided (for example sensor data, metadata and/or image data) can be preprocessed in order to obtain a feature vector which is used as the input for the ML model.

The authentication unit may be a smart key (key fob) or a mobile device, for instance a programmable mobile telephone (smartphone) or a so-called wearable (mobile device which can be worn on the body). The ToF distance measurement of the distance between the authentication unit and the motor vehicle and the further reception signal may be based on one or more signals of an ultra-wideband (UWB) signal transmission. Other high-frequency (HF, also radio frequency, RF) or low-frequency (LF) signal transmissions can nevertheless also be used for the ToF distance measurement of the distance between the authentication unit and the motor vehicle and for the further reception signal.

The ToF distance measurement of the distance between the authentication unit and the motor vehicle and the further reception signal may be used as input values for the ML model, and information relating to the corresponding relative position of the authentication unit with respect to the motor vehicle may be provided by the ML algorithm as an output value. Alternatively, the further reception signal may be used as an input value for the ML model, and environment information from the ML algorithm can be provided as an output value. In this case, the input values are also referred to as so-called “features”. In order to train an ML model (using a so-called supervised learning approach), the corresponding input data and output data are used as training input data and training output data and the ML algorithm is trained to provide a transformation which generates corresponding output data for all training data sets from the training input data.

ML models can be trained using training input data. The examples mentioned above use a training method which is called “supervised learning”. In supervised learning, the ML algorithm is trained using a plurality of training data units, wherein each data unit comprises one or more training input data items and one or more desired output values, that is to say a desired output value is assigned to the combination of the one or more training input data items. As a result of both training input data and desired output values being specified, the ML algorithm “learns” which output value needs to be provided on the basis of input data which are similar to the training input data provided during training. In the presented method, the data from the ToF distance measurement of the distance between the authentication unit and the motor vehicle and the further reception signals therefore also represent the training input data, and the relative position of the authentication unit with respect to the motor vehicle represents the output data, that is to say also the training output data. In other words, the ML model is trained to output the position of the authentication unit relative to the motor vehicle if data from a ToF distance measurement of the distance between the authentication unit and the motor vehicle and further reception signals are applied to the input(s) of the ML model.

In the present case, the ML model is trained to determine the environment information on the basis of the further reception signal. For this purpose, the time-of-flight and/or the signal strength and/or the signal waveform of the further reception signal may be used as input data and/or as training input data for the ML model. In other words, the ML model can be trained to determine environment information on the basis of data from a further reception signal. Alternatively or additionally, the ML model can be trained to determine a relative position of an authentication unit with respect to a motor vehicle on the basis of the reception signal and the further reception signal. In other words, the ML model can be trained to determine environment information on the basis of data from a reception signal and a further reception signal.

Training data are recorded as soon as the environment has been analyzed by the vehicle. Training data are then linked to the features of the environment analysis and an ML model is formed on this basis, which now provides improved interior/exterior recognition. As soon as the motor vehicle receives the signal from an approaching authentication unit, it analyzes the environment and feeds its data from the further reception signal, in addition to its data from the reception signal that can be used to carry out a ToF distance measurement of the authentication unit with respect to the motor vehicle, into the ML algorithm. In this case, the time-of-flight, the signal strength and the signal waveform of the received signal with respect to the transmitted signal waveform of the transmission signal are relevant. Direct paths, that is to say LOS paths, should be filtered out from the further reception signal since no environment information can be found therein. The principle resembles a UWB radar. In other words, information from the further reception signal and from the transmission signal can be used as features of the ML model. As a result, the ML model can be trained during operation of a motor vehicle. Training of the ML model can be improved by comparing output data from the ML algorithm for an environment of a location with a data set assigned to this location. For example, a location may have a rigid environmental structure, for example a low reinforced concrete ceiling, and movable structures, for example automobiles which are parking. The output data from the ML algorithm can then be compared with the assigned data set of a location with regard to determination of the rigid environmental structure and a discrepancy can be determined. In other words, the data set assigned to a location can be used as training output data. Alternatively or additionally, training input data and training output data for training the ML model can be generated at a location at which a well-defined environment can be created, for example in a laboratory. At this location, the environment can be divided into sections by means of a grid, with the result that the training output data, that is to say the desired output values, for small sections are known and can be transferred to the ML model. The ML model can then be trained using the training input data set provided by the further reception signal.

In the further method 100a according to the invention, an ML model is therefore trained using training data. In this case, the training data may comprise only information relating to an environment that can be determined by means of a further reception signal. The training data may then be used to train the ML model, with the result that the ML algorithm, starting from a further reception signal, provides environment information, that is to say in other words a data set for a location, as an output. This output and the transmission signal can then be used to improve determination of the relative position of the authentication unit of the motor vehicle. Alternatively or additionally, training data for training the ML model may contain information from the transmission signal, for example a ToF distance measurement of the authentication unit with respect to the motor vehicle. An output of the ML algorithm could then be the relative position of the authentication unit of the motor vehicle, thus making it possible to improve determination of the relative position of the authentication unit of the motor vehicle.

It will be appreciated that the examples described above are not restricted to one further reception signal and/or one environment, but rather also apply to a plurality of further reception signals and/or environments. For example, it is possible to generate a plurality of training data sets with a plurality of further reception signals and/or a plurality of well-defined environments in a laboratory.

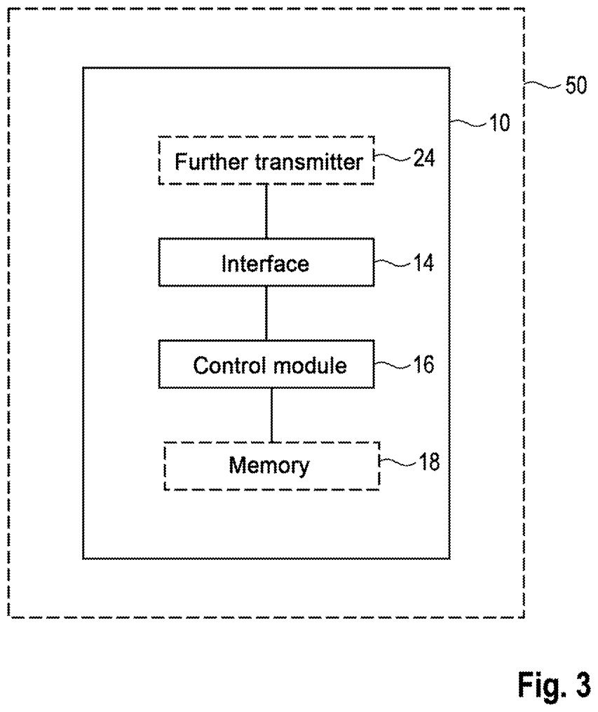

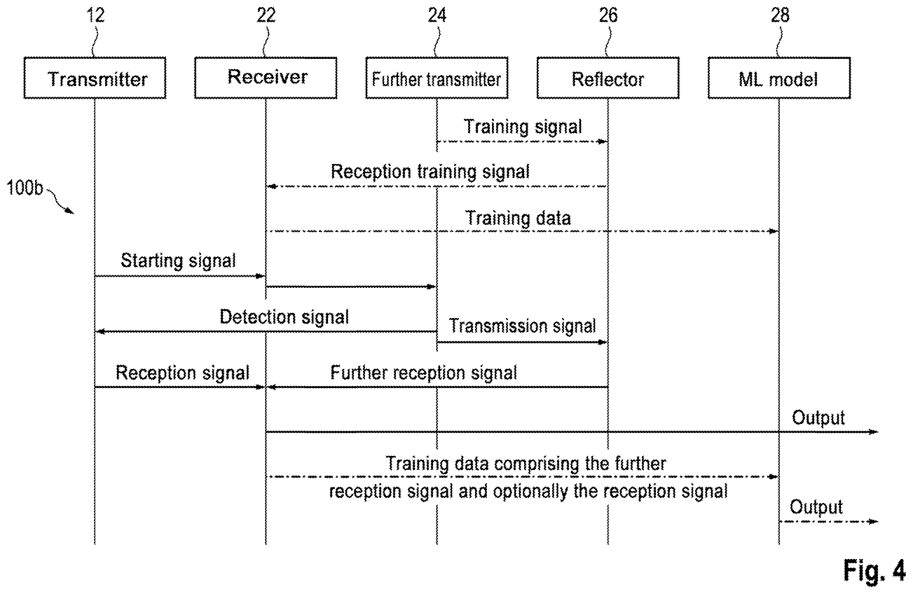

More details and aspects of the method and of the device are mentioned in connection with the concept or examples described above (FIG. 1) or below (FIGS. 3-4). The method and the device may comprise one or more additional optional features corresponding to one or more aspects of the proposed concept or of the described examples, as described above or below.

FIG. 3 shows a block diagram of an exemplary embodiment of a device according to the invention. The device 10 comprises a receiver for locating an authentication unit of a motor vehicle, having at least one interface 14 for communicating with one or more further transmitters and a control module 16 which is designed to carry out a method according to the invention. The device may optionally have one or more further transmitters 24 and one or more memories 18. The functionality of the device is generally provided by the control module 16 and the interface 14 with the aid of the optional further transmitters 24 and/or the optional memories 18.

The interface 14 may correspond, for example, to one or more inputs and/or one or more outputs for receiving and/or transmitting information, for instance in digital bit values, on the basis of a code, within a module, between modules or between modules of different entities.

In exemplary embodiments, the control module 16 may correspond to any desired controller or processor or a programmable hardware component. For example, the control module 16 may also be in the form of software which is programmed for a corresponding hardware component. In this respect, the control module 16 may be implemented as programmable hardware with accordingly adapted software. In this case, any desired processors, such as digital signal processors (DSPs), can be used. In this case, exemplary embodiments are not restricted to a particular type of processor. Any desired processors or a plurality of processors are conceivable for implementation.

The one or more memory devices 18 may comprise, for example, at least one element of the group comprising a computer-readable storage medium, a magnetic storage medium, an optical storage medium, a hard disk, a flash memory, a floppy disk, a random access memory, a programmable read-only memory (PROM), an erasable programmable read-only memory (EPROM), an electronically erasable programmable read-only memory (EEPROM) and a network memory.

FIG. 3 also shows an optional motor vehicle 100 which comprises a device 10. In addition, the motor vehicle 100 may also comprise a further transmitter 24, which is designed to generate a transmission signal, wherein the control module is also designed to receive a further reception signal from the further transmitter or a reflector and to determine the environment information on the basis of the further reception signal.

More details and aspects of the method and of the device are mentioned in connection with the concept or examples described above (FIGS. 1-2) or below (FIG. 4). The method and the device may comprise one or more additional optional features corresponding to one or more aspects of the proposed concept or of the described examples, as described above or below.

FIG. 4 shows a message sequence chart of a method according to the invention. The method 100b comprises a transmitter 12 for transmitting/receiving signals, a receiver 22 for receiving signals, a further transmitter 24 for transmitting signals, a reflector 26 for reflecting signals and an ML model 28 with an ML algorithm for outputting an output value. The receiver 22 can be informed of the presence of the transmitter 12 by virtue of the transmitter 12, for example the authentication unit, transmitting a starting signal, for example a Bluetooth signal. The receiver 22 then prompts the further transmitter 24 to transmit a detection signal to the transmitter 12. In response to the detection signal, the transmitter 12 transmits a reception signal to the. A ToF distance measurement of the transmitter 12 with respect to the receiver 22 can then be carried out from the reception signal. Furthermore, the receiver 22 can prompt the further transmitter 24 to transmit a transmission signal. The transmission signal may be reflected at a reflector 26, thus generating a further reception signal which can be received by the receiver 22. An environment of the location can be determined on the basis of the transmission signal and the further reception signal, and the relative position of the authentication unit with respect to the motor vehicle can then be determined in combination with the ToF distance measurement. Alternatively or additionally, an environment of the location may be determined using the ML model. For this purpose, the data from the transmission signal and the further reception signal may be transferred to the ML model 28 as a feature. An ML algorithm can then provide the environment information as an output value. The relative position of the authentication unit with respect to the motor vehicle can then be determined using this environment information and the ToF distance measurement. In addition, the reception signal may be transferred to the ML model 28 as a feature. The ML algorithm can then provide the relative position of the authentication unit with respect to the motor vehicle as an output value. Optionally, upon reaching a location, for example upon reaching a destination indicated in the navigation device, and optionally upon switching-off of the motor vehicle engine, the further transmitter 24 may transmit a training signal. The training signal may be used for reflection at the reflector 26, as a result of which a reception training signal from the reflector 26 can be received by the receiver 22. The reception training signal may be transmitted to the ML model in the form of training data. It will be appreciated that the at least one interface and the control module and optionally the memory are configured such that the described method can be carried out.

More details and aspects of the method and of the device are mentioned in connection with the concept or examples described above (FIGS. 1-3). The method and the device may comprise one or more additional optional features corresponding to one or more aspects of the proposed concept or of the described examples, as described above or below.

The aspects and features which are described together with one or more of the examples and figures detailed above can also be combined with one or more of the other examples in order to replace an identical feature of the other example or to additionally introduce the feature into the other example.

Examples may also be or relate to a computer program having a program code for carrying out one or more of the above methods when the computer program is executed on a computer or processor. Steps, operations or processes of different methods described above may be carried out by means of programmed computers or processors. Examples may also cover program memory devices, for example digital data storage media, which are machine-readable, processor-readable or computer-readable and code machine-executable, processor-executable or computer-executable programs of instructions. The instructions carry out some or all of the steps of the methods described above or cause them to be carried out. The program memory devices may comprise or be, for example, digital memories, magnetic storage media, for example magnetic disks and magnetic tapes, hard disk drives or optically readable digital data storage media. Further examples may also cover computers, processors or control units which are programmed to carry out the steps of the methods described above, or (field-)programmable logic arrays ((F)PLAs) or (field-)programmable gate arrays ((F)PGAs) which are programmed to carry out the steps of the methods described above.

The description and drawings present only the principles of the disclosure. Furthermore, all examples mentioned here are intended to be used expressly only for illustrative purposes, in principle, in order to assist the reader in understanding the principles of the disclosure and the concepts contributed by the inventor(s) for further development of the art. All statements herein regarding principles, aspects and examples of the disclosure and also specific examples thereof encompass the counterparts thereof.

Functions of different elements shown in the figures including any function blocks referred to as “means”, “means for providing a signal”, “means for generating a signal”, etc. can be implemented in the form of dedicated hardware, e.g. “a signal provider”, “a signal processing unit”, “a processor”, “a controller”, etc., and as hardware capable of executing software in conjunction with associated software. When provided by a processor, the functions can be provided by a single dedicated processor, by a single jointly used processor or by a plurality of individual processors, some or all of which can be used jointly. However, the term “processor” or “controller” is far from being limited to hardware capable exclusively of executing software, but rather can encompass digital signal processor hardware (DSP hardware), a network processor, an application-specific integrated circuit (ASIC), a field-programmable logic array (FPGA), a read-only memory (ROM) for storing software, a random access memory (RAM) and a non-volatile memory device (storage). Other hardware, conventional and/or customized, can also be included.

A block diagram can illustrate for example a rough circuit diagram which implements the principles of the disclosure. In a similar manner, a flow diagram, a flowchart, a state transition diagram, a pseudo-code and the like can represent various processes, operations or steps which are represented for example substantially in a computer-readable medium and are thus performed by a computer or processor, regardless of whether such a computer or processor is explicitly shown. Methods disclosed in the description or in the patent claims can be implemented by a component having a means for performing each of the respective steps of said methods.

It will be appreciated that the disclosure of a plurality of steps, processes, operations or functions disclosed in the description or the claims should not be interpreted as being in the specific order, unless this is explicitly or implicitly indicated otherwise, e.g. for technical reasons. The disclosure of a plurality of steps or functions therefore does not limit them to a specific order unless said steps or functions are not interchangeable for technical reasons. Furthermore, in some examples, an individual step, function, process or operation can include a plurality of substeps, subfunctions, subprocesses or suboperations and/or be subdivided into them. Such substeps can be included and be part of the disclosure of said individual step, provided that they are not explicitly excluded.

Furthermore, the claims that follow are hereby incorporated in the detailed description, where each claim can be representative of a separate example by itself. While each claim can be representative of a separate example by itself, it should be taken into consideration that—although a dependent claim can refer in the claims to a specific combination with one or more other claims—other examples can also encompass a combination of the dependent claim with the subject matter of any other dependent or independent claim. Such combinations are explicitly proposed here, provided that no indication is given that a specific combination is not intended. Furthermore, features of a claim are also intended to be included for any other independent claim, even if this claim is not made directly dependent on the independent claim.

1.-11. (canceled)

12. A method for a receiver for locating an authentication unit of a motor vehicle, comprising:
determining environment information relating to the receiver;
receiving a reception signal from a transmitter; and
determining a relative position of the transmitter with respect to the receiver on the basis of the environment information and the reception signal.

13. The method as claimed in claim 12, further comprising:
receiving a further reception signal from a further transmitter or a reflector, and determining the environment information based at least in part on the further reception signal.

14. The method as claimed in claim 13, wherein determining the environment information comprises a signal analysis of the further reception signal with respect to at least one of a time-of-flight, a signal strength, and a signal waveform.

15. The method as claimed in claim 14, wherein determining the relative position comprises determining the relative position using a machine learning model.

16. The method as claimed in claim 14, further comprising:
transmitting a transmission signal for reflection at the reflector in order to receive the further reception signal.

17. The method as claimed in claim 13, further comprising:
transmitting a transmission signal for reflection at the reflector in order to receive the further reception signal.

18. The method as claimed in claim 17, wherein determining the relative position comprises determining the relative position using a machine learning model.

19. The method as claimed in claim 13, wherein determining the relative position comprises determining the relative position using a machine learning model.

20. The method as claimed in claim 12, further comprising:
receiving a starting signal from the transmitter before determining the environment information.

21. The method as claimed in claim 12, further comprising:
determining the environment information using of a plurality of further reception signals.

22. The method as claimed in claim 12, wherein determining the relative position comprises determining the relative position using a machine learning model.

23. A device for a receiver for locating an authentication unit of a motor vehicle, comprising:
at least one interface for communicating with one or more transmitters; and
a control module configured to carry out the method of claim 12.

24. A motor vehicle having a device as claimed in claim 23.

25. The motor vehicle as claimed in claim 24, also comprising a further transmitter configured to generate a transmission signal, and wherein the control module is configured to receive a further reception signal from the further transmitter or a reflector and to determine the environment information on the basis of the further reception signal.

26. The motor vehicle as claimed in claim 25, wherein the control module is further configured to determine the environment information comprises a signal analysis of the further reception signal with respect to at least one of a time-of-flight, a signal strength, and a signal waveform.

27. The motor vehicle as claimed in claim 26, wherein the control module is further configured to determine the relative position using a machine learning model.

28. The motor vehicle as claimed in claim 26, wherein the control module is further configured to cause transmission of the transmission signal for reflection at the reflector in order to receive the further reception signal.

29. A computer program having a program code for carrying out at least the method as claimed in claim 12 when the program code is executed on a computer, a processor, a control module or a programmable hardware component.
